(19) United States
(12) Patent Application Publication
(10) Pub. No.: US 2007/0081608 A1
(43) Pub. Date: Apr. 12, 2007

(54) Method for increasing accuracy for estimating MIMO channel

(76) Inventors: Hong-Sup Lee, Seoul (KR); Hyun-Kyu Chung, Daejeon (KR); Kwang-Chun Lee, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/517,128

(22) Filed: Sep. 7, 2006

(30) Foreign Application Priority Data
Oct. 12, 2005 (KR) 10-2005-0121342

(51) Int. Cl. H04L 1/02; H04L 27/06

(52) U.S. Cl. 375/267; 375/343

(57) ABSTRACT

The present invention relates to a method for increasing accuracy for estimating a multiple input multiple output (MIMO) channel. In the method, a maximum delay spread of a channel is estimated by using a Gold code or a Kasami code, a loosely-synchronous (LS) code having an appropriate interference free window (IFW) is selected, and the MIMO channel without any interference is accurately estimated.

### CROSS-REFERENCE TO RELATED APPLICATION

This application claims priority to and the benefit of Korean Patent Application No. 10-2005-0121342 filed in the Korean Intellectual Property Office on Dec. 10, 2005, the entire contents of which are incorporated herein by reference.

### BACKGROUND OF THE INVENTION

(a) Field of the Invention

The present invention relates to a method for increasing accuracy for estimating a multiple input multiple output (MIMO) channel. More particularly, the present invention relates to a method for accurately estimating a MIMO channel without any interference after estimating a maximum delay spread of a channel by using a Gold code or a Kasami code, and selecting a loosely-synchronous code having an appropriate interference free window (IFW) according to the estimated maximum delay spread.

(b) Description of the Related Art

A multiple input multiple output (MIMO) system uses a plurality of antennas to quickly transmit data, and it is appropriate for a next generation communication system for mainly processing multimedia data including moving pictures. In such a MIMO communication system, performance greatly varies according to channel characteristics, compared to a conventional communication system.

An eigenvalue of a MIMO channel matrix or a static independency of rank or channel matrix elements may affect the performance of the MIMO communication system. Accordingly, it is required to accurately estimate the MIMO channel when the MIMO communication system is used.

In addition, a plurality of antennas are used at a receiving terminal and a transmission terminal when the MIMO channel is estimated.

FIG. 1 shows a diagram of receiving antennas and transmitting antennas in a conventional MIMO channel environment.

All the signals transmitted from the respective transmitting antennas are added and transmitted to a receiving antenna. For example, a signal y1 received at a first receiving antenna in FIG. 1 is formed by adding signals transmitted from the respective transmitting antennas through respective channels h11, h12, . . . , and h1nT, and the other signals received at the other receiving antennas are formed in a like manner, which is shown in Equation 1.
y1=h11x₁+h12x₂+ . . . +h1n_{T}xₙ_{_{T}} [Equation 1]

By using the received signals, the receiving terminal may calculate a matrix H indicating the MIMO channel. The MIMO channel matrix H is given as Equation 2.

$$H = [ \begin{matrix}h 11 & h 12 & ⋯ & h 1 {n}_{T} \\ ⋮ & ⋮ & ⋰ & ⋮ \\ h {n}_{R} 1 & h {n}_{R} 2 & ⋯ & h {n}_{R} {n}_{T}\end{matrix} ] \qquad [ Equation 2 ]$$

It is required to identify respective transmission signals from among the received signals to calculate h11, h12, . . . , and hnRnT corresponding to a channel impact response.

B. H. Fleury et al. used a time division multiplexing (TDM) configuration and estimated the MIMO channel in 2002. Here, in the TDM configuration, a plurality of transmitting antennas transmit signals at respective times allocated to the respective antennas, and only the signal transmitted from one transmitting antenna is received at one receiving antenna at a predetermined time. That is, in the TDM configuration, a transmitting terminal and a receiving terminal respectively use a switch, and they may transmit or receive a signal through a predetermined antenna at an allocated time. In this case, switching times of the transmitting and receiving terminals are required to be synchronized.

However, there are problems in estimating the MIMO channel in the TDM configuration. It is assumed that a radio channel is not easily changed during a divided time period in a method for estimating the MIMO channel by using the TDM configuration. Accordingly, the method using the TDM may not be used in a channel that is quickly changed. In addition, since a signal has reduced accuracy during a transient time, the method using the TDM may not be used to estimate a channel. Further, since data stored in the receiving terminal to estimate a channel are increased in the TDM configuration, there may be a problem when a capacity of a storage unit in a receiving terminal is not great.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for accurately estimating a multiple input multiple output (MIMO) channel without any interference by selecting a loosely-synchronous (LS) code having an appropriate interference free window (IFW) after estimating a maximum delay spread of a channel by using a Gold code or a Kasami code.

In an exemplary method for estimating the MIMO channel by a receiving terminal of an MIMO communication system according to an embodiment of the present invention, a) predetermined code information transmitted through a pilot signal is used, and a maximum value is detected among maximum delay spread values for respective paths forming the MIMO channel, b) the detected maximum value is used, n pieces of loosely-synchronous (LS) code information satisfying a predetermined condition is selected (here, n is the number of transmitting antennas), and the selected LS code information is transmitted to a transmitting terminal, and c) final LS code information selected by using the LS code information selected in b) is received from the transmitting terminal, and the MIMO channel is estimated.

In an exemplary method for estimating a multiple input multiple output (MIMO) channel by a transmitting terminal of an MIMO communication system according to another embodiment of the present invention, a) a pilot signal having predetermined code information is transmitted to a receiving terminal, b) selected loosely-synchronous (LS) code information satisfying a predetermined condition is received from the receiving terminal, and c) final LS code information is extracted according to the selected LS code information, and the final LS code information is transmitted to the receiving terminal.

### BRIEF DESCRIPTION OF THE DRAWINGS

FIG. 1 shows a diagram of receiving antennas and transmitting antennas in a conventional MIMO channel environment.

FIG. 2 shows a diagram representing an auto-correlation and a cross-correlation of a loosely-synchronous (LS) code.

FIG. 3 shows a flowchart representing a method for increasing an accuracy of MIMO channel estimation according to an exemplary embodiment of the present invention.

FIG. 4 shows a block diagram of an internal configuration of a device using the Gold code to estimate a channel impact response for respective paths forming the MIMO channel and calculate a maximum delay spread value, according to the exemplary embodiment of the present invention.

FIG. 5 shows a block diagram of an internal configuration of a device for estimating the MIMO channel by transmitting the LS code information from a transmitting terminal to receiving terminals, according to the exemplary embodiment of the present invention.

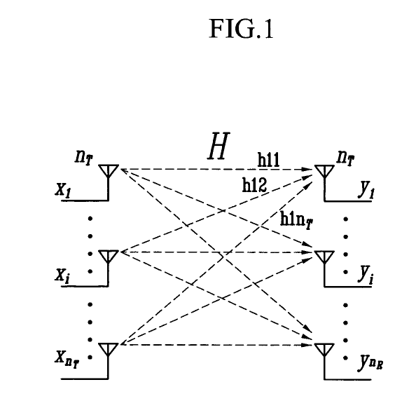

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprise”, and variations such as “comprises” or “comprising”, will be understood to imply the inclusion of stated elements but not the exclusion of any other elements.

A device for increasing accuracy for estimating a multiple input multiple output (MIMO) channel according to an exemplary embodiment of the present invention and a method thereof will be described with reference to figures.

In the exemplary embodiment of the present invention, the accuracy for estimating the MIMO channel is increased by using a Gold code (or Kasami code) and a loosely-synchronous (LS) code.

The Gold code is used in a code division multiple access (CDMA) system since it has great cross-correlation characteristics. The CDMA system uses an orthogonal characteristic between LS codes to identify user channels. That is, since the LS code is allocated to a user or a channel that is required to be identified, the orthogonality between users or channels may be maintained.

In the LS code, an auto-correlation value is maximized and a cross-correlation value between the LS codes is 0 when there is no phase difference. That is, there is a characteristic in which the cross-correlation between the LS codes having no phase difference (i.e., the synchronized LS codes) is 0.

A period called an interference free window (IFW) exists in the LS code, and there is no interference in the IFW period. That is, the LS code has a characteristic in which the auto-correlation and the cross-correlation are 0 in the IFW period.

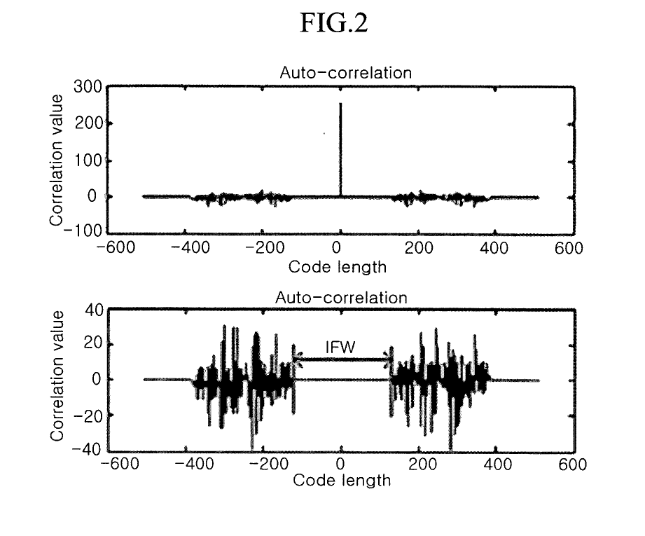

FIG. 2 shows a diagram representing the auto-correlation and the cross-correlation of the LS code. In FIG. 2, the auto-correlation value and the cross-correlation value are 0 when a phase difference has a predetermined range based on a phase difference of 0.

When such an LS code is used, an interference caused by multipaths and an interference caused by signals from other users may be considerably reduced. That is, regardless of a multipath used by a user to transmit a transmission signal or a multipath used by another user to transmit another transmission signal, the signal to interference ratio is improved and the data rate is actually increased since the correlation value of signals received during the IFW period is 0.

In addition, since the cross-correlation value of the LS code is 0 during a predetermined period, the cross-correlation value is 0 when signals are not perfectly synchronized with another user.

According to the IFW characteristic of the LS code, signals concurrently transmitted from a plurality of transmitting antennas may be identified without any interference, and therefore a channel may be accurately estimated.

However, to increase the accuracy of the channel estimation by using the IFW characteristic of the LS code, lengths of all the channel impact responses, which are elements of the MIMO channel H, are required to be lower than IFW/2. When the lengths are not lower than IFW/2, a considerable amount of interference occurs at the transmitting terminal and the receiving terminal, and performance is deteriorated.

Accordingly, in the exemplary embodiment of the present invention, a maximum delay spread of a channel is estimated by using the Gold code or the Kasami code, the LS code having an appropriate IFW period is selected, and the MIMO channel is accurately estimated without any interference.

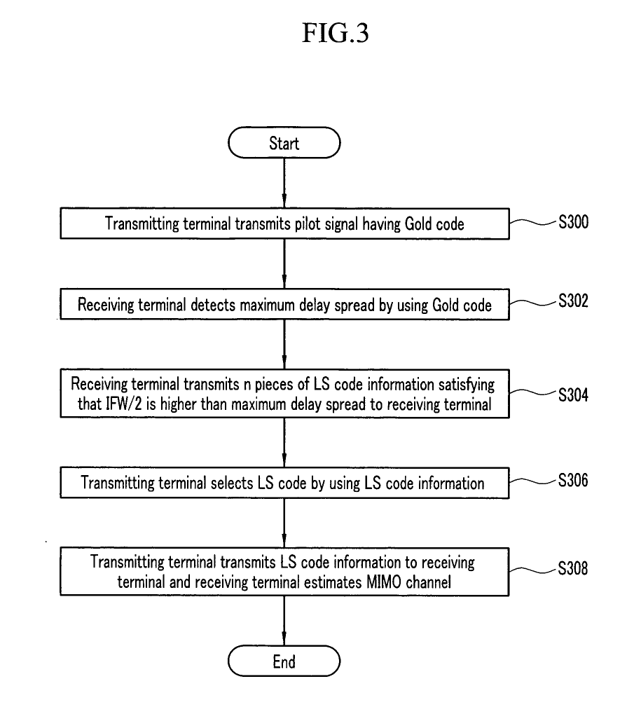

A method for increasing the accuracy of the MIMO channel estimation will be described with reference to FIG. 3.

A transmitting terminal transmits a pilot signal having the Gold code to a receiving terminal so as to calculate a maximum delay spread value in step S300.

Subsequently, by using the Gold code, the receiving terminals receiving the Gold code detect a maximum value from among the maximum delay spread values for respective paths forming the MIMO channel in step S302. To accurately identify the signals transmitted from the plurality of transmitting antennas, the receiving terminal selects n pieces of LS code information (here, n is the number of transmitting antennas) satisfying that IFW/2 is higher than the maximum delay spread value, and transmits the LS code information to the transmitting terminal in step S304.

According to the LS code information transmitted from the receiving terminal, the transmitting terminal determines an LS code to be transmitted to the receiving terminal in step S306. Then, the transmitting terminal transmits the different pieces of LS code information to the receiving terminal through the respective transmitting antennas. The receiving terminal estimates the MIMO channel in step S308 by using the LS code information.

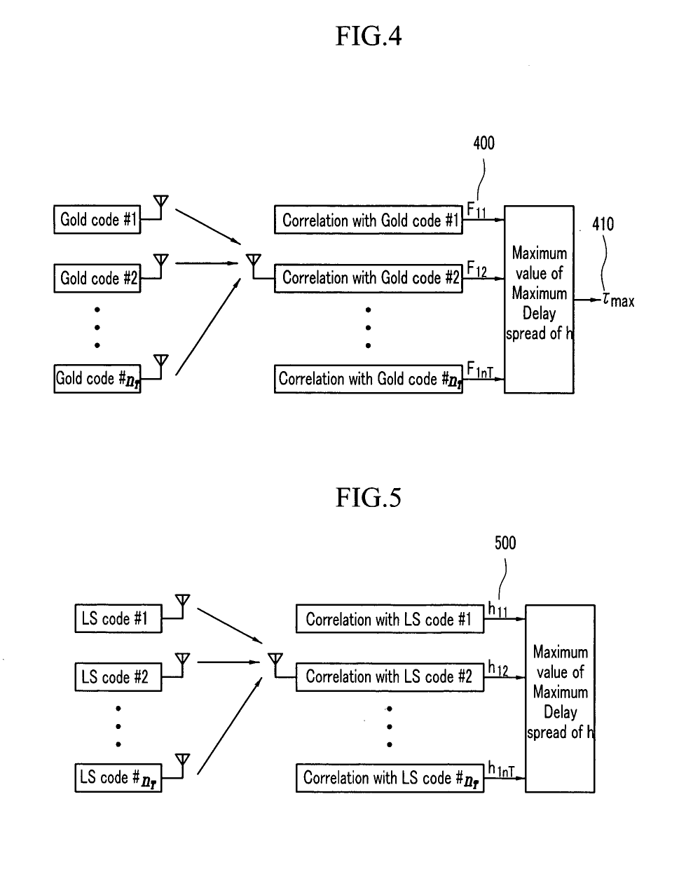

FIG. 4 shows a block diagram of an internal configuration of a device using the Gold code to estimate the channel impact response for the respective paths forming the MIMO channel and calculate the maximum delay spread value, according to the exemplary embodiment of the present invention.

One receiving antenna is illustrated in FIG. 4, and a configuration including a plurality of receiving antennas is the same as the configuration shown in FIG. 4.

Due to incompleteness of the cross-correlation value of the Gold code, channels h̅₁̅₁̅, h̅₁̅₂̅, . . . , h̅₁̅ₙ̅_̅{̅_̅{̅T̅}̅}̅ (F₁₁, F₁₂, . . . , and F_{1nT}) 400 estimated by using the Gold code include an interference signal caused by a signal transmitted from another transmitting antenna. When the above channels are used as channel estimation values, the accuracy is reduced compared to an actual channel value.

Accordingly, the channels h̅₁̅₁̅, h̅₁̅₂̅, . . . , h̅₁̅ₙ̅_̅{̅_̅{̅T̅}̅}̅ (F₁₁, F₁₂, . . . , and F_{1nT}) 400 are used for data used to calculate the maximum delay spread value. A maximum value among the calculated maximum delay spread values of the respective channels is τₘₐₓ 410.

To find the LS code having IFW>2τₘₐₓ relates to a length L of the LS code. When the length of the LS code is L, it is easy to find the LS code having the IFW that is L/8. When the number of transmitting antennas is 2, it is possible to find mate-pair LS codes having the IFW that is L/4.

FIG. 5 shows a block diagram of an internal configuration of a device for estimating the MIMO channel by transmitting the LS code information from the transmitting terminal to the receiving terminals, according to the exemplary embodiment of the present invention.

The transmitting terminal transmits the selected LS code information to the receiving terminal through the respective transmitting antennas. The receiving terminal may obtain the MIMO channel H by using the received signal from the respective antennas and the respective LS codes.

The interference is 0 since h₁₁, h₁₂, . . . , h₁ₙ_{_{T}} 500 of the obtained MIMO channel H are estimated within the IFW of which cross-correlation value of the LS code is 0, and therefore, the h₁₁, h₁₂, . . . , h₁ₙ_{_{T}} 500 are close to the actual channel value compared to the h̅₁̅₁̅, h̅₁̅₂̅, . . . , h̅₁̅ₙ̅_̅{̅_̅{̅T̅}̅}̅ (F₁₁, F₁₂, . . . , and F_{1nT}) 400.

According to the exemplary embodiment of the present invention, the MIMO channel is accurately estimated without any interference when the plurality of transmitting antennas concurrently transmit signals.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, according to the exemplary embodiment of the present invention, when the MIMO channel is estimated, the accurate channel estimation value may be obtained without using the TDM configuration.

In addition, since the TDM configuration is not used in the exemplary embodiment of the present invention, a quickly changed channel may be estimated, an additional device for synchronizing the switch timings between the transmitting terminal and the receiving terminal is not necessary, and there is no need to eliminate the estimated data which are eliminated due to a switch time.

What is claimed is:

1. A method for estimating a multiple input multiple output (MIMO) channel by a receiving terminal of an MIMO communication system, the method comprising:
a) using predetermined code information transmitted through a pilot signal, and detecting a maximum value among maximum delay spread values for respective paths forming the MIMO channel;
b) using the detected maximum value, selecting n pieces of loosely-synchronous (LS) code information satisfying a predetermined condition (here, n is the number of transmitting antennas), and transmitting the selected LS code information to a transmitting terminal; and
c) receiving final LS code information selected by using the LS code information selected in b) from the transmitting terminal, and estimating the MIMO channel.

2. The method of claim 1, wherein the predetermined condition in b) is that an interference free window (IFW)/2 is greater than the maximum value (here, the IFW is a period in which there is no interference of the LS code).

3. The method of claim 1, wherein the predetermined code information is Gold code information or Kasami code information.

4. A method for estimating a multiple input multiple output (MIMO) channel by a transmitting terminal of an MIMO communication system, the method comprising:
a) transmitting a pilot signal having predetermined code information to a receiving terminal;
b) receiving selected loosely-synchronous (LS) code information satisfying a predetermined condition from the receiving terminal; and
c) extracting final LS code information according to the selected LS code information, and transmitting the final LS code information to the receiving terminal.

5. The method of claim 4, wherein the predetermined condition in b) is that an interference free window (IFW)/2 is greater than a maximum value among maximum delay spreads for respective paths forming the MIMO channel (here, the IFW is a period in which there is no interference of the LS code).

6. The method of claim 4, wherein b) comprises:
receiving the selected LS code information;
using the selected LS code information;
extracting n different pieces of LS code information (here, n is a number of transmitting antennas); and
transmitting the extracted LS code information.
